(19) United States
(12) Patent Application Publication
(10) Pub. No.: US 2026/0208450 A1
(43) Pub. Date: Jul. 23, 2026

(54) THERMOPLASTIC COMPOSITE AND METHOD FOR PRODUCING THEREOF FOR REINFORCING STRUCTURE

(71) Applicant: Arkema France, Puteaux (FR)

(72) Inventors: Alexander ZOLLER, LACQ (FR); Pierre GERARD, LACQ (FR)

(73) Assignee: Arkema France, Puteaux (FR)

(21) Appl. No.: 19/142,474

(22) PCT Filed: Dec. 22, 2023
(86) PCT No.: PCT/EP2023/087781

§ 371 Date: Jun. 23, 2025

(30) Foreign Application Priority Data
Dec. 23, 2022 (FR) FR2214451

(51) Int. Cl. B29C 70/00; B29C 70/54; B29K 33/00; B29K 105/10; C08J 5/04

(52) U.S. Cl. CPC B29C 70/003; B29C 70/54; C08J 5/042; C08J 5/043; B29K 2033/08; B29K 2105/106; C08J 2333/12

(57) ABSTRACT

The invention relates to a thermoplastic composite comprising:
at least one straight portion having a circular section with an external diameter, and a longitudinal axis,
at least one bent portion,
at least one bending radius, of the at least one bent portion the bending radius being at most a factor f equal to 5 with respect to the external diameter of the at least one straight portion, and
a thermoplastic matrix and a fiber reinforcement.

The invention also relates to a structure to be reinforced comprising at least one thermoplastic, uses of a thermoplastic composite and a method for producing a thermoplastic composite.

### FIELD OF THE INVENTION

The present invention relates to the field of construction. In particular, the invention relates to the field of thermoplastic composite for the reinforcement of structures.

This invention provides a new thermoplastic composite and a method for producing a thermoplastic composite preferably for reinforcing structure.

### DESCRIPTION OF RELATED ART

In various constructions, construction sites and civil engineering sites related to buildings or structures, construction materials are frequently used, and reinforcing bars (rebars) are often used as construction materials.

Usually, a rebar is a steel bar used as a tensioning device in reinforced structure and preferably in reinforced concrete and/or reinforced masonry structures to reinforce and help the concrete/mortar under tension. Currently, rebars are used in many fields from construction to aerospace.

For example, concrete is a very strong material in compression, but weak in tension (flexural strength) and shear. It exhibits brittle behavior at breakage/fracture. To compensate for this imbalance, the incorporation into the concrete mass of reinforcing bars is intended to take up these forces and provide ductility. Masonry, with its mortar joints, has the same weaknesses as concrete. To improve tensile strength, rebars are also incorporated into masonry structures. The same is true for most of the structures to be reinforced in the various fields of application of rebars.

Furthermore, the structures to be reinforced have complex arrangements and formations which have evolved over time and with demand. The distribution of resistance characteristics then becomes inhomogeneous a fortiori in complex formations (i.e. comprising at least one angle or at least one corner).

In addition, the distribution of the reinforcement bars within a structure to be reinforced has become greatly limited by the shape of this structure, or even the shape of the filling formwork and certain locations within the structure and/or of the formwork are left empty. Nevertheless, with the evolution of the fields of application, new geometric shapes are necessary and their reinforcement too.

Furthermore, within a rebar itself, the stress varies along its length in a tension zone. Indeed, a sufficient extension of the length of the rebar beyond the point where said rebar must develop its elastic limit is necessary to prevent the rupture of the rebar. This length must also be at least equal to the development length. However, if the actual length available is insufficient for full development, then the structure is at risk of cracking or even collapsing.

The most common type of rebars is steel rebar, usually made of hot-rolled round bars with raised deformation patterns in its surface. These rebars are generally longitudinal. They have some advantages such as their resistance to bending (flexural strength). However, they are susceptible to corrosion leading to deterioration. To improve the adhesion with the structure to be reinforced and the chemical resistance, several solutions have been developed.

For example, stainless steels from iron alloys are well known for being corrosion resistant, but they are very expensive.

Another example concerns steel rebars with coating, generally an epoxy resin. Indeed, the surface of the rebars presents a roughness (for example rib) to promote better adhesion with the concrete/mortar and reduce the risk of slipping. However, these coatings tend to making the coated rebar more expensive than a basic steel rebar and may have lower mechanical properties. Indeed, the coating is applied to the rebar once it has been produced. During shaping such as bending or even when connecting with other rebars, the coating cracks or breaks causing a reduction in the mechanical and chemical properties of the reinforcement bar and consequently of the structure to be reinforced.

Other types of rebar are made of fiber reinforcement polymer (FRP), such as fiberglass, carbon fiber or basalt fiber and usually embedded in a thermosetting resin. With a thermosetting resin, it is no longer possible to modify the shape of the rebar once it has been produced and shaped. Additionally, it is not possible to produce thermosetting rebars without precise instruction of the needs on the structure to be reinforced resulting in long production and supply times. Moreover, once shaped, these thermosetting rebars do not tolerate any modification even minor. Furthermore, thermosetting rebars have other drawbacks such as long cycle times, high energy consumption, low recyclability of the materials used, toxicity of certain components and the emission of volatile organic compounds particularly during the manufacture of bent/shaped rebar. In addition, it is well known that thermosetting polymers and particularly bent rebars cannot be applied universally due to the high transport volume and storage.

Additionally, with current bent thermosetting rebars the point of curvature includes compression of the fibers which become unable to withstand tension and drastically reduces the reinforcement of the structures. Moreover, nowadays thermoset need to be shaped manually within the pultrusion process which requires additional costs and time. So, it is not possible to adapt the thermosetting rebars to the structure to be reinforced or to modify them after cooling. The same problem occurs with steel due to the epoxy coating and thus epoxy-coated rebars.

The design and application of non-metallic reinforcing bars presents many challenges. Indeed, the behavior of these reinforcing materials differs from the behavior of metals, for example in terms of shear strength, creep and elasticity. However, it is necessary to ensure good mechanical properties.

Additionally, the current rebars (such as stainless steel, epoxy and thermoset) are placed with bar supports and/or spacers separating the rebars from the concrete/mortar formwork to establish a concrete/mortar cover and ensure proper embedment and to avoid corrosion. The rebars in the formwork are connected by spot welding, by tying steel wire, or with mechanical connections. To connect epoxy coated or galvanized rebars, epoxy coated, or galvanized wire is normally used. All of these mechanical elements (support, spacers, welding, mechanical couplers) are an effective means of reducing the congestion of the rebars in the heavily reinforced areas for the on-site. Nevertheless, these elements require an organization of the rebars which leave little possibility to reinforce the entire structure and in particular to adapt to the various shapes of the structure to be reinforced. For example, the reinforcing bars are glued together to form a circle of predefined diameter which is not suitable for reinforcing the corners of various structures. This also reduces the space available to ensure continuous reinforcement of the structure (the distribution of resistance characteristics and the continuity of forces.

Rebars are generally longitudinal and have a curvature at their end. New forms of reinforcing bar for assembly have also been developed, such as stirrups or pins. The curvature allows the rebars to be assembled together within the formwork or structure to be reinforced.

A problem with FRPs is their efficiency with respect to shear. FRP reinforcement bars formed by bending before hardening generally have relatively poor performance compared to steel bars or straight fiber structures. When tensioned, the area between the straight and curved regions is subjected to high bending, shear, and longitudinal stresses.

Thus, for rebars made of polymers (FRP) and in particular of thermosetting polymer, the radius of curvature is 6 to 7 times the diameter of the rebar according to the formula r=f*d with, r the bending radius, f the factor between 6 and 7 (limits included) and d, the diameter preferably the external diameter of the rebar (generally between 6 mm and 30 mm, limits included). Such a factor 6 or 7 allows to prevent the curved portion from the risk of cracking and therefore of cracking within the rebar and consequently the structure. This bending radius is particularly important and increases the size in the formwork or in the structure. This also increases, for example, the amount of mass (concrete, mortar or other material) needed to fill the formwork. Finally, with such a bending radius and the consequent bulk, it is not possible to ensure continuity of forces for structures to be reinforced with complex shapes (for example at least one angle) and/or diverse. Finally, with such a bending radius, it becomes particularly difficult to assemble the rebars together.

Furthermore, the rebars are produced remotely from the construction sites and are subsequently assembled by ligature, by welding or by mechanical couplers, to form reinforcing formwork on the construction sites which will be filled with mass (concrete or mortar or other). They are usually passively embedded in the concrete/mortar before the concrete/mortar solidifies.

Thus, the rebars, whether made of steel or of thermosetting polymer, have a significant size in the structures and must be found in large numbers to provide reinforcement in tension/flexion/compression/shear. In addition, they do not allow to be able to reinforce the entirety of a structure when it has particular shapes (i.e. at least one angle) (problem of coating, fiber, connecting element, bending radius, congestion).

Furthermore, the rebars have a difficult assembly between them or with the structure to be reinforced, reducing the reinforcement of the structure, in particular with a high factor.

Finally, it also becomes important to be able to facilitate the transport and storage of the rebars while being able to present freedom in the possible forms of a structure to be reinforced.

Hence, there is a need for solutions capable of generating a new means for reinforcing structures to be reinforced which is less bulky, adapted to various shapes, having good mechanical and/or chemical properties while allowing easy anchoring to the structure to be reinforced or between the rebars.

A lower radius of curvature allows smaller structures and more liberty on design. Additionally, less material might be used, especially concrete, is smaller structures could be achieved due to lower bending radius.

There is also a need to propose rebars that can be bended as steel rebars, but are much lighter.

The document CA 2839915 discloses a bendable FRP rebar. The rebar is made of a flexible polyester as the French title indicates.

The document FR3087203 discloses a (meth)acrylic composition suitable for rebars. The rebar can be bended, but the bending radius is not mentioned.

The document FR3060577 discloses a liquid composition comprising a monomer, a (meth)acrylic polymer and at least two initiators that have a different half life time. As one possible application of the polymerized liquid composition composite rebars are mentioned, but not bending and even a bending radius.

In addition, it is advantageous for this means to be inexpensive and easily manufacturing while being easily transportable and storable. Finally, it would be interesting if this means were more easily recyclable.

### SUMMERY OF THE INVENTION

The following sets forth a simplified summary of selected aspects, embodiments and examples of the present invention for the purpose of providing a basic understanding of the invention.

However, the summary does not constitute an extensive overview of all the aspects, embodiments and examples of the invention. The sole purpose of the summary is to present selected aspects, embodiments and examples of the invention in a concise form as an introduction to the more detailed description of the aspects, embodiments and examples of the invention that follow the summary.

The invention aims to overcome the disadvantages of the prior art. In particular, the invention proposes a thermoplastic composite comprising:
at least one straight portion having a circular section with an external diameter and a longitudinal axis,
at least one bent portion,
at least one bending radius, of the at least one bent portion the bending radius being at most a factor egal to 5 with respect to the external diameter of the at least one straight portion, and
a thermoplastic matrix and a fiber reinforcement.

The advantage of this thermoplastic composite is that it presents good mechanical and/or chemical properties. The thermoplastic composite according to the invention allows an easy and simplified assembly between the thermoplastic composite or with the structure to be reinforced and improves the reinforcement of a structure to be reinforced.

The composite thermoplastic according to the invention is also less bulky, suitable for various shapes, having good mechanical and/or chemical properties while allowing easy anchoring to the structure to be reinforced or between reinforcing elements.

The thermoplastic composite according to the invention makes it possible to facilitate the transport and storage of the reinforcements while being able to present freedom in the possible shapes of a structure to be reinforced.

In addition, a thermoplastic composite according to the invention is less expensive and easy to manufacture while being easily transportable and storable.

Finally, it is more easily recyclable.

According to other optional features of the thermoplastic composite according to the invention, it can optionally include one or more of the following characteristics alone or in combination:
the thermoplastic matrix comprises a thermoplastic polymer from the family of polyamide, polyurea, polyacrylic, poly(aryl ether ketones), polyimides, aromatic polyetherimides, polysulfides, polysulfones, polyolefins, polylactic acid, polyvinyl, polyvinyl alcohol, fluoropolymers, styrenes, cellulosics, polyester and/or polycarbonates,
the thermoplastic matrix comprises a (meth)acrylic polymer,
the thermoplastic composite comprises at most 35% in volume of a thermoplastic matrix comprising (meth)acrylic polymer and at least 65% in volume of fiber,
the thermoplastic composite comprises from 20% to 50% in volume of a polymeric matrix including (meth)acrylic polymers, and from 50% to 80% in volume of fibers,
the at least one bending radius is at least a factor egal to 2 with respect to the external diameter of the at least one straight portion,
the external diameter of the at least one straight portion of the thermoplastic composite is between 4 mm and 40 mm,
the at least one bending radius is between 8 mm and 200 mm according to the formula r=d*f wherein r is the bending radius (mm), d the external diameter (mm) and f the factor wherein f is between 2 and 5 with respect to the external diameter of the at least one straight portion,
the thermoplastic composite comprises at least one bending angle, the bending angle being defined according to the longitudinal axis of the thermoplastic composite, the bending angle being between 0° and 360°, 0 excluded,
the at least one straight portion and the at least one bent portion are from the same thermoplastic matrix.

According to another aspect, the invention can also relate to a structure to be reinforced comprising at least one thermoplastic composite according to the invention. Such structure has better reinforcement and may have a longer lifetime.

The invention can also relate to the use of a thermoplastic composite according to the invention in automotive, transport, nautical, railroad, aeronautic, aerospace, photovoltaic, construction and building, concrete reinforcement, masonry, civil engineering and/or wind energy applications. A composite thermoplastic according to the invention is advantageously suitable for any type of field and makes it possible to reinforce structures in several fields.

The invention can also concern the use of a thermoplastic composite according to the invention as reinforcing element, construction material, hook, multiple link, stirrup, anchor, pile, fixer, chaining, header, coupler, connector, plug, splicing, fitting, support, frame, strut, spacer, cage, T bar, I bar, splice bar, slice bar, longitudinal bar, transversal bar, continuity bar, a panel, a rod, a rebar and/or a sheet. A thermoplastic composite according to the invention can take several forms and therefore can be used in various and varied ways without modifying said thermoplastic composite.

According to another aspect, the present invention can also relate to a method for producing a thermoplastic composite comprising at least one straight portion having a circular section with an external diameter and a longitudinal axis, and at least one bent portion, the method comprising:
A step of providing the thermoplastic composite with at least one straight portion having a circular section with an external diameter, said thermoplastic composite comprising a thermoplastic matrix and a fiber reinforcement,
A step of heating a portion of the thermoplastic composite, preferably from, conduction, convection, radial and/or volumetric heating,
A step of creating at least one bent portion in the heated portion by bending the heated portion according to a bending radius, the bending radius being at most a factor egal to 5 with respect to the external diameter of the at least one straight portion of the thermoplastic composite,
A step of cooling the at least one bent portion to form a thermoplastic composite comprising at least one straight portion and at least one bent portion.

The method according to the invention allows to produce a thermoplastic composite easily and in a less expensive way: The method allow to produce a thermoplastic composite with a lower bending radius while having improved mechanical and/or chemical properties.

The foregoing and other objects, features and advantages of the present invention will become more apparent from the following detailed description when taken in conjunction with the accompanying drawings in which:

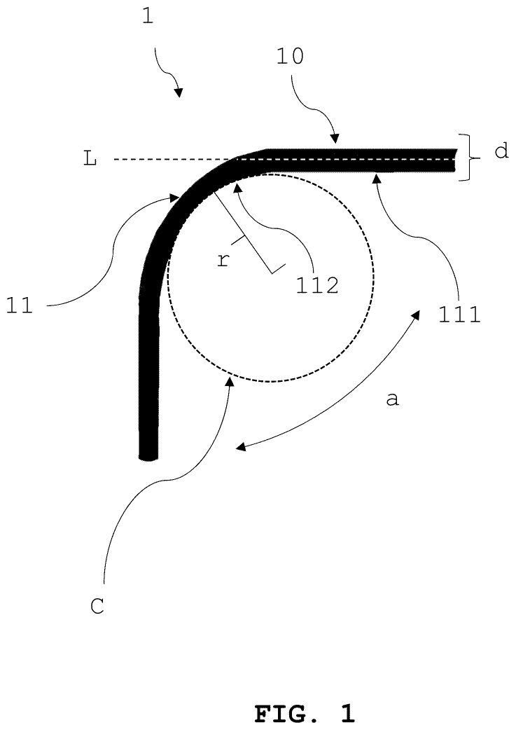

FIG. 1 is a schematic view of a thermoplastic composite according to an embodiment of the present invention.

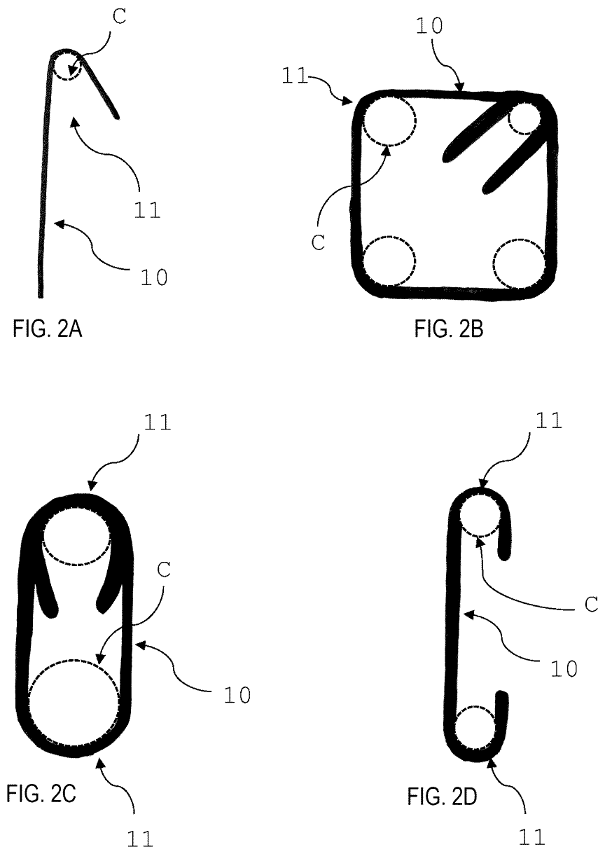

FIG. 2A is a schematic view of a shape of a thermoplastic composite according to an embodiment of the present invention.

FIG. 2B is a schematic view of a shape of a thermoplastic composite according to an embodiment of the present invention.

FIG. 2C is a schematic view of a shape of a thermoplastic composite according to an embodiment of the present invention.

FIG. 2D is a schematic view of a shape of a thermoplastic composite according to an embodiment of the present invention.

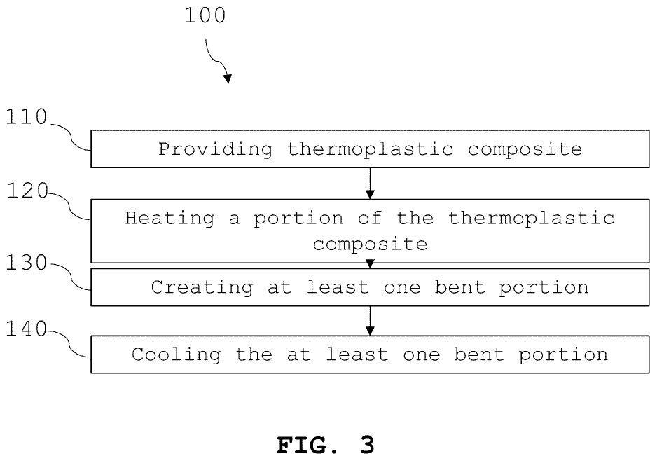

FIG. 3 is a flowchart of a method according to an embodiment of the present invention.

Several aspects of the present invention are disclosed with reference to flow diagrams and/or block diagrams of methods, and devices according to embodiments of the invention.

On the figures, the flow diagrams and/or block diagrams show the architecture, the functionality and possible implementation of devices or systems or methods, according to several embodiments of the invention.

For this purpose, each box in the flow diagrams or block diagrams may represent a system, a device, a module which comprises several executable instructions for implementing the specified logical function(s).

In some implementations, the functions associated with the box may appear in a different order than indicated in the drawings.

For example, two boxes successively shown, may be executed substantially simultaneously, or boxes may sometimes be executed in the reverse order, depending on the functionality involved.

Each box of flow diagrams or block diagrams and combinations of boxes in flow diagrams or block diagrams may be implemented by special systems that perform the specified functions or actions or perform combinations of special equipment and computer instructions.

### DETAILED DESCRIPTION

A description of example embodiments of the invention follows.

By “polymer” is meant either a copolymer or a homopolymer or a block copolymer. The term “copolymer” means a polymer grouping together several different monomer units and the term “homopolymer” means a polymer grouping identical monomer units. By “block copolymer” is meant a polymer comprising one or more uninterrupted blocks of each of the distinct polymer species, the polymer blocks being chemically different from each other and being linked together by a covalent bond. These polymer blocks are also called polymer blocks.

The expression “polymer composite”, within the meaning of the invention, denotes a multicomponent material comprising at least two immiscible components in which at least one component is a polymer, and the other component may for example be a fibrous reinforcement.

By “fibrous reinforcement” or “fibrous substrate” or “fibers” is meant, within the meaning of the invention, several fibers, unidirectional fibers or of braids, or a continuous filament mat, fabrics, felts, or nonwovens which may be under the form of bands, webs, braids, wicks or pieces.

The term “matrix” can refer to a material serving as a binder and capable of transferring forces to the fibrous reinforcement.

The “polymer matrix” may include polymers but can also include other compounds or materials.

The “(meth)acrylic polymer matrix” may refer to all types of compounds, polymers, oligomers, copolymers or block copolymers, acrylics and methacrylics. However, it would not be departing from the scope of the invention if the (meth)acrylic polymer matrix comprises up to 10% by weight, preferably less than 5% by weight of other non-acrylic monomers, chosen for example from the group: butadiene, isoprene, styrene, substituted styrene such as a-methylstyrene or tert-butylstyrene, cyclosiloxanes, vinylnaphthalenes and vinyl pyridines.

The term “initiator”, or “precursor” within the meaning of the invention, can refer to a compound which can start/initiate the polymerization of a monomer or of monomers.

The term “polymerization” within the meaning of the invention can refer to the process of converting a monomer or a mixture of monomers into a polymer.

The term “monomer”, within the meaning of the invention, can refer to a molecule which can undergo polymerization.

For the purposes of the invention, the term “thermoplastic polymer” can refer to a polymer which is generally solid at room temperature, which may be crystalline, semi-crystalline or amorphous, and which softens during an increase in temperature, in particular after passing its glass transition temperature (Tg) and flowing at a higher temperature and/or being able to observe a clear melting at the passage of its so-called melting temperature (Tf) (when it is semi-crystalline), and which becomes solid again when the temperature drops below its melting point and below its glass transition temperature. This also applies for thermoplastic polymers slightly crosslinked by the presence of multifunctional monomers or oligomers in the formulation of the “syrup” (meth)acrylate, in percentage by mass preferably less than 10%, preferably less than 5% and so preferred less than 2% and may be at least 0.5%, which can be thermoformed when heated above the softening temperature. The Tg and Tm may be determined by differential scanning calorimetry (DSC) according to the standards 11357-2:2013 and 11357-3:2013 respectively.

The term “thermoplastic composition” can refer to a thermoplastic syrup or thermoplastic resin or a thermoplastic resin precursor.

The term “thermosetting polymer” can refer to a plastic material which irreversibly transforms by polymerization.

The term “(meth)acrylic monomer” can refer to any type of acrylic and methacrylic monomer.

The term “(meth)acrylic polymer” can refer to a polymer essentially comprising (meth)acrylic monomers which represent at least 50% by weight or more of the (meth)acrylic polymer.

The term “PMMA”, within the meaning of the invention, can refer to homopolymers and copolymers of methyl methacrylate (MMA), the weight ratio of MMA in the PMMA preferably being at least 70% by weight for the MMA copolymer.

The expression “reinforcing element” as used can refer to an element used within/with a structure in order to strengthen it, support it, solidify it, consolidate it, improve its mechanical properties (reinforcement, tension, stretching, etc.) its thermal, electrical and/or chemical properties.

The term “rebar” can refer to a reinforcing bar that is used as a tension device in reinforced concrete and reinforced masonry structures to strengthen and aid the concrete under tension. Rebar significantly increases the tensile strength of concrete of the structure.

The expression “structure” or “structure to be reinforced” or “concrete structure” or “masonry structures” or “mortar structure” or “formwork” may refer to all structure which are usually reinforced, or which need to be reinforced. For example, something (such as building) that is constructed or constitution, arrangement, and assembly of the elements of a building, or more especially of the elements which form its framework. In addition, concrete or mortar may be used equally. A structure to be reinforced may be any type of structure that requires reinforcement preferably by a reinforcing element. Such structure to be reinforced may comprise concrete and/or mortar and/or a polymeric matrix with fiber. Preferably a structure can correspond to any structure comprising poured concrete.

The abbreviation “phr” can refer to parts by weight per hundred parts of composition. For example, 1 phr of initiator in the composition means that 1 kg of initiator is added to 100 kg of composition.

The abbreviation “ppm” can refer to parts by weight per million parts of composition. For example, 1000 ppm of a compound in the composition means that 0.1 kg of the compound is present in 100 kg of the composition.

In the following description “bending radius” may refer to the level of curvature of a reinforcing element. The bending radius may be the radius of the circle named Osculating circle. The osculating circle may be the circle which “fits a curve there as best as possible”. In other words, the bending radius is the absolute value of the radius of the circle tangent to the curve (osculating circle) and whose diameter is perpendicular to said tangent. The bending radius is well known in the field of rebars. As for example for steel rebars as disclosed by Branz “Site-bending of reinforcing steel” in Build, october/November 2004, pages 22+24.

The term “about” as used herein can allow for a degree of variability in a value or range, for example, within 10%, within 5%, or within 1% of a stated value or of a stated limit of a range.

As mentioned, the current rebars do not ensure continuity of forces in the structures to be reinforced. Indeed, their bulk within the structure or during their assembly is significant. They also have a difficult assembly with each other or with the structure to be reinforced, reducing the reinforcement of the structure. The resistance is then inhomogeneous.

In addition, certain types of rebar have reduced mechanical properties either by the presence of a coating, a bending crack or even cracking of the reinforcing fibers.

The rebars are also difficult to transport and store and require significant costs and time during their production.

Finally, at present the reinforcement bars are not designed to improve their recyclability, or even that of the structure, or even allow the reduction of CO₂ consumption.

There is a need for a new means for reinforcing structures to be reinforced which is compact, less bulky, adapted to various shapes, exhibiting good mechanical and/or chemical properties with uniform resistance while allowing easy assembly to the structure to be reinforced or between the rebars. There is also a need for a new means of reinforcement allowing it to be easily transported to construction sites or easily stored. Finally, it is always advantageous to be able to improve costs and production time in the field of industry. Moreover, it is just as relevant that this new method is more respectful of the environment.

The current rebars do not allow these objectives to be achieved either because the rebar is made of stainless steel, which increases costs, or made of steel with a coating as epoxy-coating that cracks on bending, or are difficult to assemble, transport and store because they are made of thermosetting polymer and therefore brittle on bending, difficult to implement, and not very adaptable.

A new thermoplastic composite has been developed.

According to a first aspect, the invention relates to a thermoplastic composite 1.

Preferably the new thermoplastic composite is suitable to reinforce structure, more preferably intended for reinforcing structure and even more preferably the new thermoplastic composite is for reinforcing structure.

The structure is preferably a structure in construction that needs reinforcement. It can be any structure concrete, mortar or other building material. A structure to be reinforced can have any shape or size.

The thermoplastic composite may be a reinforcing element, a construction material, a hook, multiple link, stirrup, anchor, pile, fixer, chaining, header, coupler, connector, plug, splicing, fitting, support, frame, strut, spacer, cage, T bar, I bar, splice bar, slice bar, longitudinal bar, transversal bar, continuity bar, a panel, a rod, a rebar, and/or a sheet and preferably a rebar. According to an embodiment, the thermoplastic composite may comprise several sheets.

In particular, as illustrated in FIG. 1, a thermoplastic composite 1 comprises at least one straight portion 10 and at least one bent portion 11.

The thermoplastic composite may comprise a matrix (generally a polymeric matrix with thermoplastic polymer) and fibers (as fibrous substrate). Such thermoplastic composites are often produced by a pultrusion process and the matrix comes from a thermoplastic composition.

According to the invention the thermoplastic composite 1 comprises a thermoplastic matrix and a fiber reinforcement.

As explained, thermoplastic composite is generally solid at room temperature, which may be crystalline, semi-crystalline or amorphous, and which softens during an increase in temperature, in particular after passing its glass transition temperature (Tg) and flowing at a higher temperature and/or being able to observe a clear melting at the passage of its so-called melting temperature (Tf) (when it is semi-crystalline), and which becomes solid again when the temperature drops below its melting point and below its glass transition temperature. Advantageously, this makes it possible to be able to transport the composite thermoplastic more easily as well as to facilitate its storage.

According to a first embodiment A, the thermoplastic matrix may comprise a thermoplastic polymer from the family of polyamide, polyurea, polyacrylic, poly(aryl ether ketones), polyimides, aromatic polyetherimides, polysulfides, polysulfones, polyolefins, polylactic acid, polyvinyl, polyvinyl alcohol, fluoropolymers, styrenes, cellulosics, polyester and/or polycarbonates.

Preferably, the thermoplastic polymers that are incorporated into the thermoplastic composition for the thermoplastic matrix, may be chosen from the family of polyamide, polyurea, polyacrylic, poly(aryl ether ketones), polyimides, aromatic polyetherimides, polysulfides, polysulfones, polyolefins, polylactic acid, polyvinyl, polyvinyl alcohol, fluoropolymers, styrenes, cellulosics, polyester and/or polycarbonates.

More preferably, the thermoplastic polymers that are incorporated into the thermoplastic composition for the thermoplastic matrix may be chosen from family of polymers and copolymers of aliphatic or cycloaliphatic polyamides (PAs) or semiaromatic PAS (also referred to as polyphthalamides (PPAS)), amorphous polyamide, polyamide (nylon), poly(ether-block-amide) s (PEBAS), polyureas, aromatic polyureas, polyacrylates, and more particularly polymethyl methacrylate (PMMA) or derivatives thereof, poly(aryl ether ketones) (PAEK) such as poly(ether ether ketone) (PEEK), or poly(aryl ether ketone ketones) as (PAEKK) such poly(ether ketone ketone) (PEKK) or derivatives thereof, aromatic polyetherimides (PEIs), polyaryl sulfides, in particular polyphenylene, sulfides (PPSs), polyaryl sulfones, in particular polyphenylene sulfones (PPSUS), polyolefins, in particular polypropylene (PP), polylactic acid (PLA), polyvinyl alcohol (PVA), fluoropolymers, in particular poly(vinylidene fluoride) (PVDF) or polytetrafluoroethylene (PTFE) or polychlorotrifluoroethylene (PCTFE), polystyrene, acrylonitrile butadiene styrene (ABS), polyethylene, polyethylene terephthalate (PET), polyethylene, glycolised polyethylene terephthalate (PET-G), polycarbonate, polyvinyl, polyvinyl acetate, polyvinyl chlorides (PVC), polyvinylidene chloride, polyurethane, polyacetals, polybutylene terephthalate (PBT), polyphenyl sulfide and/or blends thereof.

Advantageously, the thermoplastic polymers constituting the thermoplastic matrix may be prepolymers and/or polymers chosen from the family of polyamides (PAS), in particular chosen from aliphatic polyamides, cycloaliphatic polyamides, and semi-aromatic polyamides (polyphthalamides) optionally modified by urea moieties, and copolymers thereof, polymethyl methacrylate (PPMA) and copolymers thereof, polyetherimides (PEIs), polyphenylene sulfide (PPS), polyphenylene sulfone (PPSU), poly(vinylidene fluoride) (PVDF), poly(ether ketone ketone) (PEKK), poly(ether ether ketone) (PEEK), fluoropolymers such as poly(vinylidene fluoride) (PVDF).

A thermoplastic composite may comprise 60% or less in volume of a polymeric matrix including a thermoplastic polymer, preferably a thermoplastic polymer selected from polyamide, polypropylene, polyether, poly(meth)acrylic and/or polyester. A thermoplastic composite may comprise preferably 55% or less in volume of a polymeric matrix and more preferably 50% or less in volume of a polymeric matrix. A thermoplastic composite may comprise 30% or more in volume of a polymeric matrix, preferably 35% or more in volume of a polymeric matrix and more preferably 40% or more in volume of a polymeric matrix. According to an embodiment, the thermoplastic composite may comprise between 30% and 60% in volume of a polymeric matrix, preferably between 35% and 55% in volume of a polymeric matrix and more preferably between 40% and 50% in volume of a polymeric matrix.

The thermoplastic composite may comprise at least 40% in volume of fibers, preferably at least 45% in volume of fibers and more preferably at least 50% in volume of fibers. According to an embodiment, the thermoplastic composite may comprise at most 70% in volume of fibers, preferably at most 65% in volume of fibers and more preferably at most 60% in volume of fibers. According to an embodiment, the thermoplastic composite may comprise between 40% and 70% in volume of fibers, preferably between 45% and 65% in volume of fibers and more preferably between 50 and 60% in volume of fibers.

A thermoplastic composite may comprise from 30% to 60% in volume of a polymeric matrix and from 40% to 70% in volume of fibers.

According to a second embodiment B, the thermoplastic matrix may comprise a thermoplastic polymer from the family of acrylic polymer and preferably from (meth)acrylic polymer and even more preferably from polymethyl methacrylate.

The thermoplastic composite may comprise at least 50% in volume of fibers, preferably at least 55% in volume of fibers and more preferably at least 60% in volume of fibers and even more preferably at least 65% in volume. According to an embodiment, the thermoplastic composite may comprise at most 80% in volume of fibers, preferably at most 75% in volume of fibers and more preferably at most 70% in volume of fibers. According to an embodiment, the thermoplastic composite may comprise between 50% and 80% in volume of fibers, preferably between 55% and 75% in volume of fibers and more preferably between 60 and 70% in volume of fibers and even more preferably between 65% and 70% in volume of fibers.

A thermoplastic composite may comprise 50% or less in volume of a polymeric matrix including (meth)acrylic polymers, preferably 45% or less in volume of a polymeric matrix including (meth)acrylic polymers and more preferably 40% or less in volume of a polymeric matrix including (meth)acrylic polymers and even more preferably 35% or less in volume of a polymeric matrix including (meth)acrylic polymers. A thermoplastic composite may comprise 20% or more in volume of a polymeric matrix including (meth)acrylic polymers, preferably 25% or more in volume of a polymeric matrix including (meth)acrylic polymers and more preferably 30% or more in volume of a polymeric matrix including (meth)acrylic polymers. According to an embodiment, the thermoplastic composite may comprise between 20% and 50% in volume of a polymeric matric including (meth)acrylic polymers, preferably between 25% and 45% in volume of a polymeric matric including (meth)acrylic polymers and more preferably between 30% and 40% in volume of a polymeric matric including (meth)acrylic polymers and even more preferably between 35% and 40% in volume of a polymeric matrix including (meth)acrylic polymer.

A thermoplastic composite may comprise from 20% to 50% in volume of a polymeric matrix including (meth)acrylic polymers, and from 50% to 80% in volume of fibers.

A thermoplastic composite may comprise 35% or less in volume of a polymeric matrix including (meth)acrylic polymers, and at least 65% in volume of fibers.

According to the first and/or the second embodiment, the fibers may be made of several fibers, unidirectional rovings or continuous filament mat, fabrics, felts or nonwovens that may be in the form of strips, laps, braids, locks or pieces. The fibrous material of the composite may have various forms and dimensions, either one-dimensional, two-dimensional or three-dimensional.

The one-dimensional form corresponds to linear long fibers. The fibers may be discontinuous or continuous. The fibers may be arranged randomly or parallel to each other, in the form of a continuous filament. A fiber is defined by its aspect ratio, which is the ratio between the length and diameter of the fiber. Preferably, the fibers used in the present invention are long fibers or continuous fibers. The fibers may have an aspect ratio of at least 1000, preferably at least 1500, more preferably at least 2000, advantageously at least 3000 and more advantageously at least 5000, even more advantageously at least 6000, more advantageously still at least 7500 and most advantageously at least 10 000.

The two-dimensional form corresponds to nonwoven or woven fibrous mats or reinforcements or bundles of fibers, which may also be braided. Even if the two-dimensional form has a certain thickness and consequently in principle a third dimension, it is considered as two-dimensional according to the present invention.

The three-dimensional form corresponds, for example, to nonwoven fibrous mats or reinforcements or stacked or folded bundles of fibers or mixtures thereof, an assembly of the two-dimensional form in the third dimension.

The origins of the fibrous material may be natural or synthetic. As natural material one can mention plant fibers, wood fibers, animal fibers or mineral fibers.

Natural fibers are, for example, sisal, jute, hemp, flax, cotton, coconut fibers, and banana fibers. Animal fibers are, for example, wool or hair.

As synthetic material, mention may be made of polymeric fibers chosen from fibers of thermosetting polymers, of thermoplastic polymers, of polyamide (aliphatic or aromatic), polyester, polyvinyl alcohol, polyolefins, polyurethanes, polyvinyl chloride, polyethylene, acrylic, unsaturated polyesters, epoxy resins and vinyl esters, and/or carbon fibers or mixtures thereof.

The mineral fibers may also be chosen from glass fibers, especially of E, R or S2 type, boron fibers, basalt fibers or silica fibers.

The fibrous substrate of the present invention may be chosen from plant fibers, wood fibers, animal fibers, mineral fibers, synthetic polymeric fibers, glass fibers and carbon fibers, and mixtures thereof.

Preferably, the fibrous substrate is chosen from mineral fibers. More preferably the fibrous substrate is chosen from glass fibers or carbon fibers.

The fibers of the fibrous substrate can have a diameter between 0.005 μm and 100 μm, preferably between 1 μm and 50 μm, more preferably between 5 μm and 30 μm and advantageously between 10 μm and 25 μm.

Preferably, the fibers of the fibrous substrate of the present invention are chosen from continuous fibers (meaning that the aspect ratio does not necessarily apply as for long fibers) for the one-dimensional form, or for long or continuous fibers for the two-dimensional or three-dimensional form of the fibrous substrate.

According to the second embodiment, the thermoplastic composite may comprise a thermoplastic matrix. Preferably the thermoplastic matrix may comprise a thermoplastic composition. More preferably, the thermoplastic matrix comes from a thermoplastic composition.

The thermoplastic composition may be a thermoplastic resin or a thermoplastic resin precursor. The thermoplastic composition may comprise at least 50% in weight of monomers of the thermoplastic polymer. The thermoplastic composition may comprise a polymer and a monomer.

Preferably the monomer of the thermoplastic composite is selected from alkyl acrylic monomers, alkyl methacrylic monomers, hydroxyalkyl acrylic monomers and hydroxyalkyl methacrylic monomers, and mixtures thereof.

Preferably the polymer of the thermoplastic composite is selected from all types of compounds, polymers, oligomers, copolymers or block copolymers, acrylics and methacrylics. However, it would not be departing from the scope of the invention if the (meth)acrylic polymer matrix comprises up to 10% by weight, preferably less than 5% by weight of other non-acrylic monomers, chosen for example from the group: butadiene, isoprene, styrene, substituted styrene such as α-methylstyrene or tert-butylstyrene, cyclosiloxanes, vinylnaphthalenes and vinyl pyridines.

The thermoplastic composition according to the invention may comprise between 10 wt % and 50 wt % of a (meth)acrylic polymer (PI) and between 50 wt % and 90 wt % of a (meth)acrylic monomer (Ml). Preferably the thermoplastic composition comprises between 10 wt % and 40 wt % of a (meth)acrylic polymer (PI) and between 60 wt % and 90 wt % of a (meth)acrylic monomer (Ml); and more preferably between 10 wt % and 30 wt % of a (meth)acrylic polymer (PI) and between 70 wt % and 90 wt % of a (meth)acrylic monomer (Ml).

The dynamic viscosity of the thermoplastic composition is in a range from 10 mPa*s to 10000 mPa*s, preferably from 20 mPa*s to 7000 mPa*s and advantageously from 20 mPa*s to 5000 mPa*s and more advantageously from mPa*s 20 mpa*s to 2000 and even more advantageously between 20 mPa*s and 1000 mPa*s. The viscosity of the thermoplastic composition can be easily measured with a Rheometer or viscosimeter. The dynamic viscosity is measured at 25° C. If the thermoplastic composition has a Newtonian behavior, meaning no shear thinning, the dynamic viscosity is independent of the shearing in a rheometer or the speed of the mobile in a viscometer. If the thermoplastic composition has a non-Newtonian behavior, meaning shear thinning, the dynamic viscosity is measured at a shear rate of 1s⁻¹ at 25° C. As regards thermoplastic composition of the invention it comprises a (meth)acrylic monomer (Ml) and a (meth) acrylic polymer (PI). Once polymerized the (meth)acrylic monomer (Ml) is transformed to a (meth)acrylic polymer (P2) comprising the monomeric units of (meth)acrylic monomer (Ml) and other possible monomers.

Preferably dynamic viscosity of the (meth)acrylic composition MCI is also in a range from 10 mPa*s to 10000 mPa*s, preferably from 20 mPa*s to 7000 mPa*s and advantageously from 20 mPa*s to 5000 mPa*s and more advantageously from 20 mPa*s to 2000 mPa*s and even more advantageously between 20 mPa*s and 1000 mPa*s.

As regards the (meth)acrylic polymer (PI), mention may be made of polyalkyl methacrylates or polyalkyl acrylates. According to a preferred embodiment, the (meth)acrylic polymer (PI) is polymethyl methacrylate (PMMA).

According to one embodiment, the methyl methacrylate (MMA) homo- or copolymer comprises at least 70%, preferably at least 80%, advantageously at least 90% and more advantageously at least 95% by weight of methyl methacrylate.

According to another embodiment, the PMMA is a mixture of at least one homopolymer and at least one copolymer of MMA, or a mixture of at least two homopolymers or two copolymers of MMA with a different average molecular weight, or a mixture of at least two copolymers of MMA with a different monomer composition.

The copolymer of methyl methacrylate (MMA) comprises from 70% to 99.9% by weight of methyl methacrylate and from 0.1% to 30% by weight of at least one monomer containing at least one ethylenic unsaturation that can copolymerize with methyl methacrylate.

These monomers are well known, and mention may be made especially of acrylic and methacrylic acids and alkyl (meth) acrylates in which the alkyl group contains from 1 to 12 carbon atoms. As examples, mention may be made of methyl acrylate and ethyl, butyl or 2-ethylhexyl (meth)acrylate. Preferably, the comonomer is an alkyl acrylate in which the alkyl group contains from 1 to 4 carbon atoms.

According to a first preferred embodiment, the copolymer of methyl methacrylate from (MMA) comprises to 80% 99.9%, advantageously from 90% to 99.9% and more advantageously from 90% to 99.9% by weight of methyl methacrylate and from 0.18 to 20%, advantageously from 0.1% to 10% and more advantageously from 0.1% to 10% by weight of at least one monomer containing at least one ethylenic unsaturation that can copolymerize with methyl methacrylate. Preferably, the comonomer is chosen from methyl acrylate and ethyl acrylate, and mixtures thereof.

The weight-average molecular mass of the (meth)acrylic polymer (PI) should be high, which means greater than 50 000 g/mol and preferably greater than 100 000 g/mol. The weight-average molecular mass can be measured by size exclusion chromatography (SEC).

The (meth)acrylic polymer (PI) is fully soluble in the (meth) acrylic monomer (Ml) or in the mixture of (meth)acrylic monomers. It enables the viscosity of the (meth)acrylic monomer (Ml) or the mixture of (meth)acrylic monomers to be increased. The solution obtained is a liquid composition generally called a “syrup” or “prepolymer”. The dynamic viscosity value of the liquid (meth) acrylic syrup is between 10 mPa·s and 10 000 mPa·s. The viscosity of the syrup can be readily measured with a rheometer or a viscometer. The dynamic viscosity is measured at 25° C.

Advantageously, the liquid (meth)acrylic composition or syrup contains no additional voluntarily added solvent.

As regards the (meth)acrylic monomer (Ml), the monomer is chosen from alkyl acrylic monomers, alkyl methacrylic monomers, hydroxyalkyl acrylic monomers and hydroxyalkyl methacrylic monomers, and mixtures thereof.

Preferably, the (meth)acrylic monomer (Ml) is chosen from hydroxyalkyl acrylic monomers, hydroxyalkyl methacrylic monomers, alkyl acrylic monomers, alkyl methacrylic monomers and mixtures thereof, the alkyl group containing from 1 to 22 linear, branched or cyclic carbons; the alkyl group preferably containing from 1 to 12 linear, branched or cyclic carbons.

More preferably, the (meth)acrylic monomer (Ml) is chosen from alkyl acrylic monomers or alkyl methacrylic monomers and mixtures thereof, the alkyl group containing from 1 to 22 linear, branched or cyclic carbons; the alkyl group preferably containing from 1 to 12 linear, branched or cyclic carbons.

Advantageously, the (meth)acrylic monomer (Ml) is chosen from methyl methacrylate, ethyl methacrylate, methyl acrylate, ethyl acrylate, methacrylic acid, acrylic acid, n-butyl acrylate, isobutyl acrylate, n-butyl methacrylate, isobutyl methacrylate, cyclohexyl acrylate, cyclohexyl methacrylate, isobornyl acrylate, isobornyl methacrylate, hydroxyethyl acrylate and hydroxyethyl methacrylate, and mixtures thereof.

More advantageously, the (meth)acrylic monomer (Ml) is chosen from methyl methacrylate, ethyl methacrylate, methyl acrylate, ethyl acrylate, methacrylic acid, acrylic acid, n-butyl acrylate, isobutyl acrylate, n-butyl methacrylate, isobutyl methacrylate, cyclohexyl acrylate, cyclohexyl methacrylate, isobornyl acrylate, isobornyl methacrylate, and mixtures thereof.

According to a preferred embodiment, at least 50% by weight and preferably at least 60% by weight of the (meth)acrylic monomer (Ml) is methyl methacrylate.

According to a first more preferred embodiment, at least 50% by weight, preferably at least 60% by weight, more preferably at least 70% by weight, advantageously at least 80% by weight and even more advantageously 90% by weight of the monomer (Ml) is a mixture of methyl methacrylate with optionally at least one other monomer (M2).

As regards the at least one other monomer is a (meth)acrylic monomer (M2). The monomer (M2) is multifunctional. Preferably the (meth)acrylic monomer (M2) is chosen from a compound comprising at least two (meth)acrylic functions. The (meth)acrylic monomer (M2) can also be chosen from a mixture of at least two compounds (M2a) and (M2b) each respectively comprising at least two (meth)acrylic functions.

The (meth)acrylic monomer (M2) can be chosen from 1,3-butylene glycol dimethacrylate; 1, 4-butanediol dimethacrylate; 1, 6 hexanediol diacrylate; 1, 6 hexanediol dimethacrylate; diethylene glycol dimethacrylate; dipropylene glycol diacrylate; ethoxylated ethoxylated (2) bisphenol a (10) bisphenol a diacrylate; dimethacrylate; ethoxylated (3) bisphenol a diacrylate; ethoxylated (3) bisphenol a dimethacrylate; ethoxylated (4) bisphenol a diacrylate; ethoxylated (4) bisphenol a dimethacrylate; ethoxylated bisphenol a dimethacrylate; ethoxylated (10) bisphenol dimethacrylate; ethylene glycol dimethacrylate; polyethylene glycol (200) diacrylate; polyethylene glycol (400) diacrylate; polyethylene glycol (400) dimethacrylate; polyethylene glycol (400) dimethacrylate; polyethylene glycol (600) diacrylate; polyethylene glycol (600) dimethacrylate; polyethylene glycol 400 diacrylate; propoxylated (2) neopentyl glycol diacrylate; tetraethylene glycol diacrylate; tetraethylene glycol dimethacrylate; tricyclodecane dimethanol diacrylate; tricyclodecanedimethanol dimethacrylate; triethylene glycol diacrylate; triethylene glycol dimethacrylate; tripropylene glycol diacrylate; ethoxylated (15) trimethylolpropane triacrylate; ethoxylated (3) trimethylolpropane triacrylate; ethoxylated (6) trimethylolpropane triacrylate; ethoxylated (9) trimethylolpropane triacrylate; ethoxylated 5 pentaerythritol triacrylate; ethoxylated (20) trimethylolpropane triacrylate; propoxylated (3) glyceryl triacrylate; trimethylolpropane triacrylate; propoxylated (5.5) glyceryl triacrylate; pentaerythritol triacrylate; propoxylated (3) glyceryl triacrylate; propoxylated (3) trimethylolpropane triacrylate; trimethylolpropane triacrylate; trimethylolpropane trimethacrylate; tris(2-hydroxy ethyl) isocyanurate triacrylate; di-trimethylolpropane tetraacrylate; dipentaerythritol pentaacrylate; ethoxylated (4) pentaerythritol tetraacrylate; pentaerythritol tetraacrylate; dipentaerythritol hexaacrylate; 1,10 decanediol diacrylate; 1,3-butylene glycol diacrylate; 1, 4-butanediol diacrylate; 1, 9-nonanediol diacrylate; 2-(2-Vinyloxyethoxy)ethyl acrylate; 2-butyl-2-ethyl-1,3-propanediol diacrylate; 2-methyl-1, 3-propanediol diacrylate; 2-methyl-1,3-propanediyl ethoxy acrylate; 3 methyl 1, 5-pentanediol diacrylate; alkoxylated cyclohexane dimethanol diacrylate; alkoxylated hexanediol diacrylate; cyclohexane dimethanol diacrylate; ethoxylated cyclohexane dimethanol diacrylate; diethyleneglycol diacrylate; dioxane glycol diacrylate; ethoxylated dipentaerythritol hexaacrylate; ethoxylated glycerol triacrylate; ethoxylated neopentyl glycol diacrylate; hydroxypivalyl hydroxypivalate diacrylate; neopentyl glycol diacrylate; poly(tetramethylene glycol) diacrylate; polypropylene glycol 400 diacrylate; polypropylene glycol 700 diacrylate; propoxylated (6) ethoxylated bisphenol A diacrylate; propoxylated ethylene glycol diacrylate; propoxylated (5) pentaerythritol tetraacrylate; and propoxylated trimethylol propane triacrylate Preferably the (meth)acrylic monomer (M2) is chosen from ethylene glycol dimethacrylate, neopentyl glycol diacrylate, neopentyl glycol dimethacrylate, 1,4-butanediol dimethacrylate, 1, 4-butanediol diacrylate, 1,3-butylene glucol diacrylate, 1,3-butylene glycol dimethacrylate, triethylene glycol dimethacrylate and triethylene glycol diacrylate or mixtures thereof.

The (meth)acrylic monomer (M2) can be present in (meth) acrylic composition MCI between 0.01 and 10 phr by weight, preferably is present between 0.1 and 9.5 phr for 100 parts of a liquid (meth) acrylic syrup, more preferably between 0.1 and 9 phr, even more preferably between 0.1 and 8.5 phr and advantageously between 0.1 and 8 phr.

In a first more preferred embodiment the (meth)acrylic monomer (M2) is present in (meth)acrylic composition MCI between 0.01 and 9 phr and is chosen from a compound comprising two (meth) acrylic functions.

In a second more preferred embodiment the (meth) monomer (M2) is present in (meth)acrylic composition MCI between 0.01 and 9 phr and is chosen from a mixture of compounds comprising two (meth)acrylic functions.

In a third more preferred embodiment the (meth)acrylic monomer (M2) is present in (meth)acrylic composition MCI between 0.01 and 9 phr and is chosen from a mixture of compounds comprising at least two (meth)acrylic functions.

In a fourth more preferred embodiment the (meth)acrylic monomer (M2) is present in (meth)acrylic composition MCI between 0.01 and 9 phr and is chosen from a mixture of compounds comprising at least two (meth)acrylic functions. At least one compound of the mixture comprises only two (meth)acrylic functions and presents at least 50 wt % of the mixture of (meth)acrylic monomer (M2), preferably at least 60 wt %. The other compound of the mixture comprises more than two (meth)acrylic functions.

According to another embodiment, the thermoplastic composition may be a thermoplastic resin precursor.

A precursor or an initiator (Ini) will be able to start the polymerization of the (meth)acrylic monomers (Ml) and (M2), and it is chosen from a radical initiator.

Preferably the initiator (Ini) is activated by heat.

The radical initiators (Ini) can be chosen from a peroxy group comprising compound or an azo group comprising compounds and preferably from a peroxy group comprising compound.

Preferably the peroxy group comprising compound comprises from 2 to 30 carbon atoms.

Preferably the peroxy group comprising compound is chosen from diacyl peroxides, peroxy esters, peroxydicarbonates, dialkyl peroxides, peroxyacetals, hydroperoxide or peroxyketale.

The initiator (Ini) is chosen from diisobutyryl peroxide, cumyl peroxyneodecanoate, di(3-methoxybutyl) peroxydicarbonate, 1, 1, 3, 3-Tetramethylbutyl peroxyneodecanoate, cumyl peroxyneoheptanoate, di-n-propyl peroxydicarbonate, tert-amyl peroxyneodecanoate, di-sec-butyl peroxydicarbonate, diisopropyl peroxydicarbonate, di(4-tert-butylcyclohexyl) peroxydicarbonate, di-(2-ethylhexyl)-peroxydicarbonate, tert-amyl peroxyneodecanoate, tert-butyl peroxyneodecanoate, di-n-butyl peroxydicarbonate, dicetyl peroxydicarbonate, dimyristyl peroxydicarbonate, 1, 1, 3, 3-tetramethylbutylperoxypivalate, tert-butyl peroxyneoheptanoate, tert-amyl peroxypivalate, tert-butyl peroxypivalate, di-(3,5,5-trimethylhexanoyl)-peroxide, dilauroyl peroxide, didecanoyl peroxide, 2, 5-dimethyl-2,5-di(2-ethylhexanoylperoxy)-hexane, 1, 1, 3, 3-tetramethylbutyl peroxy-2-ethylhexanoate, tert-amyl peroxy-2-ethylhexanoate, dibenzoyl peroxide, tert-butyl peroxy-2-ethylhexanoate, tert-butyl peroxydiethylacetate, tert-butyl peroxyisobutyrate, 1,1-di-(tert-butylperoxy)-3,3,5-trimethylcyclohexane, 1, 1-di(tert-amylperoxy)cyclohexane, 1,1-di-(tert-butylperoxy)-cyclohexane, tert-amyl peroxy-2-ethylhexylcarbonate, tert-amyl peroxyacetate, tert-butyl peroxy-3, 5, 5-trimethylhexanoate, 2,2-di-(tert-butylperoxy)-butane, tert-butyl peroxyisopropylcarbonate, tert-butyl peroxy-2-ethylhexylcarbonate, tert-amyl peroxybenzoate, tert-butyl peroxyacetate, butyl 4, 4-di(tert-butylperoxy) valerate, tert-butyl peroxybenzoate, di-tert-amylperoxide, dicumyl peroxide, di-(2-tert-butyl-peroxyisopropyl)-benzene, 2, 5-dimethyl-2,5-di-(tert-butylperoxy)-hexane, tert-butylcumyl peroxide, 2, 5-dimethyl-2,5-di(tert-butylperoxy) hexyne-3, di-tert-butyl peroxide, 3, 6, 9-triethyl-3, 6, 9-trimethyl-1, 4, 7-triperoxonane, 2,2′-azobis-isobutyronitrile (AIBN), 2, 2 ‘-azodi-(2-methylbutyronitrile), azobisisobutyramide, 2,2’-azobis(2, 4-dimethylvaleronitrile), 1,1′-Azodi (hexahydrobenzonitrile), or 4, 4′-azobis(4-cyanopentanoic).

Preferably the initiator (Ini) is chosen from cumyl peroxyneodecanoate, di(3-methoxybutyl) peroxydicarbonate, 1, 1,3,3-tetramethylbutyl peroxyneodecanoate, cumyl peroxyneoheptanoate, di-n-propyl peroxydicarbonate, tert-amyl peroxyneodecanoate, di-sec-butyl peroxydicarbonate, diisopropyl peroxydicarbonate, di(4-tert-butylcyclohexyl) peroxydicarbonate, di-(2-ethylhexyl)-peroxydicarbonate, tert-amyl peroxyneodecanoate, tert-butyl peroxyneodecanoate, di-n-butyl peroxydicarbonate, dicetyl peroxydicarbonate, dimyristyl peroxydicarbonate, 1, 1, 3, 3-tetramethylbutylperoxypivalate, tert-butyl peroxyneoheptanoate, tert-amyl peroxypivalate, tert-butyl peroxypivalate, di-(3,5,5-trimethylhexanoyl)-peroxide, dilauroyl peroxide, didecanoyl peroxide, 2, 5-dimethyl-2,5-di(2-ethylhexanoylperoxy)-hexane or 1, 1, 3, 3-tetramethylbutyl peroxy-2-ethylhexanoate.

The thermoplastic composition may comprise between 0.1 phr and 5 phr of an initiator (Ini) to start the polymerization of the (meth)acrylic monomer (Ml) and (meth)acrylic comonomer (M2).

Such a composite thermoplastic may be bent or moldable when heated to a certain temperature and returns to a more rigid state upon cooling and repeated several times. In addition, thanks to their thermoplastic properties, it becomes easy to transport them or even to store them. Once on the site, they can then be shaped again to be adapted to the structure to be reinforced or to the assembly of the thermoplastic composites between them without limitation of shapes. Consequently, the thermoplastic composite makes it possible to adapt to various shapes and complex shapes that a structure to be reinforced may have or even to different forms of assembly of the thermoplastic composites with each other.

Back to the FIG. 1, the thermoplastic composite 1 may comprise at least one straight portion 10. The straight portion 10 may have a longitudinal axis L. The straight portion 10 may have a lower wall 111 and an upper wall, preferably according to the longitudinal axis L. The straight portion 10 may have a circular section with an external diameter d. Preferably the external diameter may be between 4 mm and 40 mm, preferably between 6 mm and 35 mm and more preferably between 8 mm and 30 mm.

Preferably, the smaller the external diameter d, the better the covering mass (concrete for example) can be reduced and avoid the bulky of structure or thermoplastic composite between them. Thus, it is possible that a structure includes more rebar and less concrete and therefore has a lower concrete volume.

Advantageously, the at least one straight portion 10 is not limited by its length.

The thermoplastic composite 1 may comprise at least one bent portion 11.

Preferably the at least one bent portion 11 may have a circular section. By circular is meant any shape reminiscent of a circle. The at least one bent portion 11 may have an external diameter. The external diameter of the at least one bent portion 11 is substantially equivalent to the external diameter d of the at least one straight portion 10 and may be between 4 mm and 40 mm. Substantially equivalent may mean a value that differs from the external diameter by 10%, preferably 58. It will be note that a variation of the external diameter of the at least one bent portion may be a sign of quality. Indeed, in fact, when the at least one bent portion of the thermoplastic composite is bent, the external diameter of the at least one bent portion increases, which reflects the presence of fiber continuity. If the diameter varies by less than 5% then this may reflect the breakage of fibers.

The at least one bent portion 11 may be bent according to the longitudinal axis L and may have an upper wall and a lower 112 wall.

Advantageously, the at least one bent portion 11 is not limited by its length.

The thermoplastic composite 1 may have at least one bending radius r.

The bending radius r may be defined as the radius of the osculating circle C of the at least one bent portion 11. Preferably the bending radius r correspond to the curvature of the bent portion 11.

The bending radius r may be calculated according to the formula r=d*f wherein r is the bending radius (mm), d the external diameter (mm) and f the factor.

The bending radius r is preferably at most a factor f egal to 5 with respect to the external diameter d of the at least one straight portion 10. Preferably the bending radius r is at most a factor f egal to 4 with respect to the external diameter d of the at least one straight portion 10 and more preferably at most a factor f egal to 3 with respect to the external diameter d of the at least one straight portion 10.

The bending radius r is preferably at least a factor f egal to 2 with respect to the external diameter d of the at least one straight portion 10.

The bending radius r may be a factor f between 2 and 5 with respect to the external diameter d of the at least one straight portion 10. Preferably the bending radius r may be a factor f between 2 and 4 with respect to the external diameter d of the at least one straight portion 10, and more preferably the bending radius r may be a factor f between 2 and 3 with respect to the external diameter d of the at least one straight portion 10.

The bending radius r may be measured by methods known to those skilled in the art (geometric or production).

The bending radius r may be between 8 mm and 200 mm preferably between 12 mm and 175 mm and more preferably between 16 mm and 150 mm.

According to an embodiment with several bending radius (several meaning at least two), the bending radius may be equal to or different from each other.

Such factor f of bending radius r allows to reduce the bulk in the structures to be reinforced. Advantageously, such a factor f also makes it easier to assemble the thermoplastic composite 1 together. The thermoplastic composite 1 takes up less space within the structure. In addition, thanks to a smaller bending radius r, this allows better continuity of forces and therefore better distribution. Consequently, the thermoplastic composite 1 makes it possible to adapt to various shapes and complex shapes that a structure to be reinforced may have or even to different forms of assembly of the thermoplastic composites 1 with each other.

Advantageously, the smaller bending radius r, the greater the flexibility of the material (thermoplastic composite), in other word the smaller the radius of curvature, the greater the curvature.

The thermoplastic composite 1 may have at least one a bending angle α.

The thermoplastic composite 1 is bent by any desired defined bending angle α (depending on the factor f of the bending radius r) around the longitudinal axis L of the thermoplastic composite 1. Preferably the bending angle α is defined according to the longitudinal axis L of the thermoplastic composite 1, more preferably according of the longitudinal axis L of the at least one straight portion 10 of the thermoplastic composite 1.

The bending angle α may be between 0° and 360°, 0 excluded. Preferably the bending angle α may be between 20° and 300, more preferably between 45° and 270°.

According to an embodiment, the bending angle x may be between 0° and n*360°, 0 excluded and n more than 1. Indeed, the bending angle α may be a multiple of 360°. For example, the bending angle α may be determined based on the length of the rebar.

The multiple is limited by the length of the thermoplastic composite 1, and without being bound by theory, thermoplastic composite 1 is not limited by its length.

According to an embodiment with several bending angles α (several meaning at least two), the bending angles α may be equal to or different from each other.

Such at least one bent portion 11 allows to vary the different possible conformation of the thermoplastic composite 1. In addition, it ensures a homogeneous resistance within the structures or between the thermoplastic composites 1.

Thus, a thermoplastic composite 1 can have different shapes and dimensions. For example, the thermoplastic composite 1 may have a V, U, J, O and/or L shape. These shapes are illustrative and do not invention. limit the Indeed, in one embodiment, the thermoplastic composite 1 may comprise at least two straight portions 10 and one bent portion 11, or at least two straight portions 10 and at least two bent portions 11. Thus, a thermoplastic composite 1 can have different shapes such as S, Z, M, and/or N. In addition, each bent portion 11 can have its own bending radius r and/or factor f, its own bending angle α, and/or its own dimension or the bent portions may be identical.

For example, as illustrated in FIGS. 2, a composite thermoplastic 1 can have different shapes in order to be in the form of an anchor FIG. 2A, a frame FIG. 2B, a stirrup FIG. 2C or even a pin FIG. 2D.

In addition, the arrangement of the portions within the thermoplastic composite 1 is not limited.

For example, a bent portion 11 can be between two straight portions 10. A straight portion 10 can be between two bent positions 11. Two bent portions 11 can be continuous.

In addition, at least one straight portion 10 and at least one bent portion 11 may be continuous with each other.

Preferably, the at least one straight portion 10 and the at least one bent portion 11 are from the same thermoplastic matrix.

Such thermoplastic composite 1 presents an improved mechanical resistance even at the level of its curvature. The flexibility is improved, and the fibers of the thermoplastic composite 1 in particular for the at least one bent portion 11, have no buckling or cracks and present a homogeneous strength. In addition, such thermoplastic composite 1 does not have degradation of its surface. Moreover, such thermoplastic composite 1 can be easily bent, and on demand, close to the site. This allows to facilitate the transport and the storage. Advantageously a thermoplastic composite 1 meets the requirement of the construction and presents similar mechanical properties to commercial steel rebar. The thermoplastic composite 1 is less expensive than stainless steel rebar and more flexible than epoxy-rebar and thermosetting rebar. The thermoplastic composite 1 is also corrosion resistant. Finally, an important advantage of the thermoplastic composite 1 resides in its mechanical properties. Such a thermoplastic composite 1 makes it possible to develop the same mechanical characteristics in the different concretes and/or mortar and/or construction material. Thus, such a thermoplastic composite 1 is suitable for any structure to be reinforced. Thanks to its thermoplastic composite 1, smaller bending radius r can be achieved, which makes it possible to improve the continuity of forces within a structure, to facilitate the arrangement in a structure or between the thermoplastic composites 1 and to reduce the bulk within the structures. Thus, the entire structure can be reinforced even when it has complex shapes.

TABLE 1
Properties following the ASTM D7957: 2020 (thermoplastic according
to the invention, preferably according to the second embodiment
of the invention B versus thermoset vinyl ester VE)

| Property for ASTM | Acceptance | | |
|---|---|---|---|
| D7957 | criteria | Thermoplastic B | VE |
| Bent section | 60% of min value | Yes | Yes |
| Bent section | 6x the rebar | Yes | Yes |
| | diameter | | |
| Bent section | 5x the rebar | Yes | Yes |
| | diameter | | |
| Bent radius | 3x the rebar | Yes | No |
| | diameter | | |

In addition, with regard to steel rebar (SR), the bent section may present a factor f between 3 and 6 except for epoxy-coated rebar which comprises for bent sections less than or equal to 5 have cracks and/or breaks. VE cannot be bent by a factor f of less than 5 unlike the thermoplastic composite according to the invention which supports without damage a section by a factor of between 3 and 6 and preferably between 2 and 6.

TABLE 2
Properties following the ASTM D7957: 2020 (thermoplastic according
to the invention, preferably according to the second embodiment
of the invention B versus thermoset vinyl ester VE)

| Property for ASTM | Acceptance | | |
|---|---|---|---|
| D7957 | criteria | Thermoplastic B | VE |
| Glass transition | Midpoint 100° C. | Yes | Yes |
| (DSC) | | | |
| Degree of Cure | 95% | Yes | Yes |
| (DSC) | | | |
| Cross-Sectional | — | Yes | Yes |
| Area | | | |
| Tensile Force | Depending on | Yes | Yes |
| | diameter 744 MPa | | |
| | for 13 mm | | |
| Tensile Modulus | 44.8 GPa | Yes | Yes |
| Tensile Strain | >1.1% | Yes | Yes |
| Transverse Shear | 131 MPa | Yes | Yes |
| Strength | | | |
| Bond Strength to | 7.7 MPa | Yes | Yes |
| concrete | | | |
| Moisture Absorption | 1% at 50° C.; <0.25% | Yes | Yes |
| | in 24 h at50° C. | | |
| Alkaline Resistance | 80% tensile force | Yes | Yes |
| | after | | |
| | 90 days/60° C./pH = 14 | | |
| Fiber | 70% in mass | yes | yes |

In addition, the same features may be found for an SR except for DSC, but for cross-sectional section, tensile modulus, tensile strain, transverse shear strength and the bound to concrete. Thus, the thermoplastic composite according to the invention has the same qualities as VE or SR. The thermoplastic composite according to the invention allows to follow the requirements of ASTM D7957. However, the SR does not include fibers which allow to improve the mechanical and chemical properties in particular to the bent section.

TABLE 3
Mechanical and/or chemical properties for a thermoplastic
composite according to the invention comprising fibers.

| | | |
|---|---|---|
| Thermoplastic composite | Strength | Modulus |
| with glass fiber | (MPa) | (GPa) |

| | | |
|---|---|---|
| Tensile 0° | 1000 | 52 |
| Transverse Shear Strength | 180 | |

| | | |
|---|---|---|
| Glass transition (Tg) | 103° | C. |

| | |
|---|---|
| Moisture Absorption (%) | 0.2% |

| | | |
|---|---|---|
| Fiber fraction (vol %) | 82 | vol % |

| | |
|---|---|
| Alkaline Resistance (%) | 86% |

The thermoplastic composite shows the same mechanical properties as a thermoset rebar. The thermoplastic composite allows to reply to the different international standards. The thermoplastic composite is bendable and does not reply to that bottleneck in the widespread application of FRP. Furthermore, it is possible to bend a thermoplastic composite according to the invention with a bending radius which is 3 times the diameter, preferably external diameter. The thermoplastic composite comprises an improved volume of fiber for higher stiffness.

According to another embodiment, the present invention relates to a structure to be reinforced comprising at least one thermoplastic composite. Preferably a thermoplastic composite according to the invention.

The structure may comprise as much thermoplastic composite as needed. For example, depending on the size, shape and/or location of the structure to be reinforced. Also, a structure to be reinforced is not limited by its shape, size, or location.

The structure may be a structure in automotive, transport, nautical, railroad, aeronautic, aerospace, photovoltaic, construction and building, concrete reinforcement, masonry, civil engineering and/or wind energies applications.

According to another aspect, the present invention relates to the use of a thermoplastic composite, preferably a thermoplastic composite according to the invention.

A thermoplastic composite preferably a thermoplastic composite according to the invention may be used in different fields. Preferably, the thermoplastic composite may be used in automotive, transport, nautical, railroad, aeronautic, aerospace, photovoltaic, construction and building, concrete reinforcement, masonry, civil engineering and/or wind energies applications.

More precisely, a thermoplastic composite, preferably according to the invention may be used as reinforcing element, construction material, hook, multiple link, stirrup, anchor, pile, fixer, chaining, header, coupler, connector, plug, splicing, fitting, support, frame, strut, spacer, cage, T bar, I bar, splice bar, slice bar, longitudinal bar, transversal bar, continuity bar, a panel, a rod, a rebar and/or a sheet.

In another aspect, the invention relates to a method for producing a thermoplastic composite, preferably a thermoplastic composite according to the invention.

As illustrated in FIG. 3, the method 100 may comprise a step of providing the thermoplastic composite 110, a step of heating 120, a step of creating at least one bent portion 130, a step of cooling 140.

As shown in FIG. 3, the method according to the invention comprises a step of providing 110 a thermoplastic composite, preferably a thermoplastic composite according to the invention.

Preferably, the thermoplastic composite is obtained by a pultrusion process. Pultrusion processes may involve drawing a bundle of fibers through a pultrusion die allowing to wet the fibers, impregnating them by passing them through a resin bath or in an injection box, polymerizing the resin and cooling the impregnated bundle to form a composite profile at the outlet of said die.

The pultrusion process allows to obtain profiles of a constant section with high mechanical properties. The thermoplastic composite is formed when it leaves the pultrusion die. During the pultrusion die, diameter and preferably external diameter are determined.

Thus, the step of providing 110 a thermoplastic composite may comprise a step of feeding, preferably by a fiber feeder device, the pultrusion die. The step of feeding fibers allows to provide fibers in a direction of a pultrusion path. Preferably, fiber as disclosed above.

The step of providing 110 a thermoplastic composite may comprise a step of wetting fibers. The step is preferably implemented by an impregnation device. The step of wetting allows fibers to be impregnated with the thermoplastic composition in other word the penetration of the thermoplastic composition into the fibers. The step of wetting fibers may comprise the passage of fibers through a thermoplastic composition, preferably as disclosed above. For example, the fibers are guided through bath or an injection chamber comprising the thermoplastic composition.

The method 100 according to the invention may comprise a step of heating 120. Preferably the step of heating is implemented by a heating device. The step of heating allows to trigger and initiate the polymerization of the thermoplastic composition which has impregnated fibers to form a heated thermoplastic composite. The step of heating may be implemented at a given temperature and/or for a given duration.

The heating allows also to increase the space between the molecules, which allows to increase the flexibility of the thermoplastic composite in order to facilitate the next step of creating at least one bent portion. As explained thermoplastic composite have the specificity of being generally solid at room temperature and while softening during an increase in temperature, in particular after passing its glass transition temperature (Tg) or the melting temperature (Tf) and becoming solid again when the temperature drops below its melting point and below its glass transition temperatures. Thanks to the step of heating, the polymerization takes place which increases the partial pressure and ensures more fluidity and flexibility; thus, the heated thermoplastic composite will be more deformable. The fibers contribute to this deformation.

For example, the Tg may be below 130° C., preferably below 120° C. and more preferably below 110° C. The glass transitions (Tg) of the polymers may be determined by differential scanning calorimetry (DSC) according to the standards 11357-2:2013.

The step of heating may comprise a heating by convection, by conduction, by IR (infrared) (comprising NIR and MIR (near and mid infrared)), by microwave, by UV (ultraviolet) and/or by induction.

According to an embodiment of the step of heating 120, the polymerization may take place at a temperature typically below 150° C., preferably below 140° C. and even more preferably below 130° C. preferably according to the B embodiment.

According to an embodiment of the step of heating, the polymerization may take place at a temperature of at least 30° C., preferably at least 40° C. and more preferably at least 50° C. and even more preferably between 80° C. and 140° C., preferably according to the B embodiment

Preferably the polymerization may take place at temperature between 30° C. and 150° C., preferably between 40° C. and 140° C., even more preferably between 50° C. and 130° C.

Advantageously, the step of heating may be implemented continuously or not.

The heating step and the polymerization allow to pass from a thermoplastic composition which has impregnated the fibers and which is liquid to a thermoplastic composite preferably with at least one straight portion having a circular section with an external diameter.

Preferably, the heating step allow to heat at least one portion of the thermoplastic composite. A portion may correspond to a part of the whole thermoplastic composite which is heated. According to an embodiment, several portions may be heated, at the same time or several portions may be heated at different times, for example as the composite thermoplastic advances.

The method according to the invention comprises a step of creating 130 at least one bent portion. Preferably, the step of creating at least one bent portion is created in the heated portion by bending the heated portion according to a bending radius and/or a bending angle. The values of the bending radius and the bending angle are preferably the same as those disclosed above. A step of creating at least one bent portion may be implemented by a bending device.

The thermoplastic composite is preferably linear according to a longitudinal axis and the step of creating a bent allows to bend the heated portion. The creating bent portion may be a bend, a curve, a complex shape, or a combination of any of the foregoing. Preferably, the bending device parameters are set to achieve a predefined bending radius and/or bending angle.

The step of creating a bent may be by simple bending, compression curving, folding and/or twisting. Preferably, the step of creating a bent includes twisting.

The method according to the invention may comprise a step of cooling 140. The step of cooling may be implemented by a cooling device. In addition, the step of cooling may be implemented at a given cooling temperature and/or for a given cooling duration.

According to an embodiment, the cooling temperature and/or the cooling duration may be selected in accordance with the glass transition temperatures (Tg) and/or the melting temperature of the heated thermoplastic composite. Preferably, the step of cooling is at a cooling temperature below to a glass transition temperature of the heated thermoplastic composite.

For example, the cooling temperature may be less than or equal to 150° C., preferably less than or equal to 130° more preferably less than or equal to 110° and even more preferably less than or equal to 100° C. The cooling temperature may be more than or equal to 50° C., preferably more than or equal to 60° C., more preferably more than or equal to 70° C. even more preferably more than or equal to 80° C. The cooling temperature may be between 50° C. and 150° C., preferably between 60° C. and 130° C., more preferably between 70° C. and 130° C., even more preferably between 80° C. and 110° C.

The step of cooling allows to produce a thermoplastic composite comprising at least one straight portion and at least one bent portion.

According to a preferred embodiment, the step of cooling may be at the same time as the step of creating. According to another embodiment, the step of cooling may be after the step of creating.

The method according to the invention may comprise other optional steps such as coating, bending, heating, cooling, cutting, welding, gluing and/or laminating. The optional step may be implemented according to the thermoplastic composite to produce. The optional step may also improve the qualities and/or properties of the thermoplastic composite.

Advantageously, the thermoplastic composite according to the invention meets all the requirements of the standard Specification for Solid Round Glass Fiber Reinforced Polymer Bars for Concrete Reinforcement.

The invention can be the subject of numerous variants and applications other than those described above. In particular, unless otherwise indicated, the different structural and functional characteristics of each of the implementations described above should not be considered as combined and/or closely and/or inextricably linked to each other, but on the contrary as simple juxtapositions. In addition, the structural and/or functional characteristics of the various embodiments described above may be the subject in whole or in part of any different juxtaposition or any different combination.

1. A thermoplastic composite comprising:
at least one straight portion having a circular section with an external diameter and a longitudinal axis,
at least one bent portion,
at least one bending radius, of the at least one bent portion the bending radius being at most a factor f equal to 5 with respect to the external diameter of the at least one straight portion, and
a thermoplastic matrix and a fiber reinforcement.

2. Thermoplastic composite according to the claim 1, wherein the thermoplastic matrix comprises a thermoplastic polymer from the family of polyamide, polyurea, polyacrylic, poly(aryl ether ketones), polyimides, aromatic polyetherimides, polysulfides, polysulfones, polyolefins, polylactic acid, polyvinyl, polyvinyl alcohol, fluoropolymers, styrenes, cellulosics, polyester and/or polycarbonates.

3. Thermoplastic composite according to the claim 2, wherein the thermoplastic composite from 30% to 60% in volume of a polymeric matrix and from 40% to 70% in volume of fibers.

4. Thermoplastic composite according to claim 1, wherein the thermoplastic matrix comprises a (meth)acrylic polymer.

5. Thermoplastic composite according to claim 4, wherein the thermoplastic composite comprises at most 35% in volume of a thermoplastic matrix comprising (meth)acrylic polymer and at least 65% in volume of fiber.

6. Thermoplastic composite according to claim 4, wherein the thermoplastic composite comprises from 20% to 50% in volume of a polymeric matrix including (meth)acrylic polymers, and from 50% to 80% in volume of fibers.

7. Thermoplastic composite according to claim 1, wherein the fibrous reinforcement is chosen from glass fibers or carbon fibers.

8. Thermoplastic composite according to claim 1, wherein the at least one bending radius is at least a factor f equal to 2 with respect to the external diameter of the at least one straight portion.

9. Thermoplastic composite according to claim 1, wherein the at least one bending radius is a factor f between 2 and 5 with respect to the external diameter of the at least one straight portion.

10. Thermoplastic composite according to claim 1, wherein the at least one bending radius is a factor f between 2 and 3 with respect to the external diameter of the at least one straight portion.

11. Thermoplastic composite according to claim 1, wherein the external diameter of the at least one straight portion of the thermoplastic composite is between 4 mm and 40 mm.

12. Thermoplastic composite according to claim 1, wherein the at least one bending radius is between 8 mm and 200 mm according to the formula r=d*f wherein r is the bending radius (mm), d the external diameter and f the factor wherein f is between 2 and 5 with respect to the external diameter of the at least one straight portion.

13. Thermoplastic composite according to claim 1, wherein the thermoplastic composite comprises at least one bending angle, the bending angle being defined according to the longitudinal axis of the thermoplastic composite, the bending angle being between 0° and 360°, 0 excluded.

14. Thermoplastic composite according to claim 1, wherein the at least one straight portion and the at least one bent portion are from the same thermoplastic matrix.

15. Structure to be reinforced comprising at least one thermoplastic composite according to claim 1.

16. (canceled)

17. An article comprising a thermoplastic composite according to claim 1, wherein the article is selected from the group consisting of a reinforcing element, construction material, hook, multiple link, stirrup, anchor, pile, fixer, chaining, header, coupler, connector, plug, splicing, fitting, support, frame, strut, spacer, cage, T bar, I bar, splice bar, slice bar, longitudinal bar, transversal bar, continuity bar, a panel, a rod, a rebar, and a sheet.

18. Method for producing a thermoplastic composite comprising at least one straight portion having a circular section with an external diameter and a longitudinal axis, and at least one bent portion, the method comprising:
A step of providing the thermoplastic composite with at least one straight portion having a circular section with an external diameter, said thermoplastic composite comprising a thermoplastic matrix and a fiber reinforcement,
A step of heating a portion of the thermoplastic composite, preferably from, conduction, convection, radial and/or volumetric heating,
A step of creating at least one bent portion in the heated portion by bending the heated portion according to a bending radius, the bending radius being at most a factor f equal to 5 with respect to the external diameter of the at least one straight portion of the thermoplastic composite,
A step of cooling the at least one bent portion to form a thermoplastic composite comprising at least one straight portion and at least one bent portion.

19. The method according to claim 18, wherein the provided thermoplastic composite has a thermoplastic matrix comprises a thermoplastic polymer from the family of acrylic polymer and preferably from (meth)acrylic polymer and even more preferably from polymethyl methacrylate.

20. The method according to claim 18, wherein the provided thermoplastic composite is obtained by a pultrusion process.

21. The method according to claim 18, wherein the step of creating a bent is made by bending, compression curving, folding and/or twisting.
